(19) United States
(12) Patent Application Publication
(10) Pub. No.: US 2021/0374780 A1
(43) Pub. Date: Dec. 2, 2021

(54) LOCATION POINT OF INTEREST GENERATION SYSTEM

(71) Applicant: Uber Technologies, Inc., San Francisco, CA (US)

(72) Inventors: Houtan Shirani-Mehr, Santa Clara, CA (US); Kapil Gupta, Sunnyvale, CA (US)

(21) Appl. No.: 17/302,445

(22) Filed: May 3, 2021

Related U.S. Application Data
(60) Provisional application No. 63/030,589, filed on May 27, 2020.

(51) Int. Cl. G06Q 30/02; G06Q 50/30; G06Q 50/14; G06F 16/29; G06F 16/9537

(52) U.S. Cl. CPC G06Q 30/0205; G06Q 50/30; G06F 16/9537; G06F 16/29; G06Q 50/14

(57) ABSTRACT

Systems and methods are provided for partitioning a geographical area to generate a plurality of partitions for the geographical area, determining a plurality of points of interest located in the geographic area, determining a popularity of each of the plurality of points of interest based on a trip count comprising at least one of a number of ridesharing pickups or a number of ride-sharing drop-offs at the point of interest, and for each partition of the plurality of partitions of the geographical area, determining one popular point of interest located within the partition and associating the one popular point of interest with the partition.

### CLAIM FOR PRIORITY

This application claims the benefit of priority of U.S Application Ser. No. 63/030,589, filed May 27, 2020, which is hereby incorporated by reference in its entirety.

### BACKGROUND

In ride sharing services, a user (e.g., rider) may request a ride (e.g., a vehicle, carpool, etc.) at a particular address or geographic coordinates via a ride-sharing application on his or her computing device (e.g., smartphone). The rider may further enter a pickup location and a destination (e.g., drop-off location). The rider, however, may enter an incorrect address or not be familiar enough with his or her surroundings to know an address to enter for a pickup or drop-off location. Moreover, GPS coordinates from the computing device may indicate that the rider is in one location when actually the rider is in a different location, causing the driver of the requested ride to miss the rider or think the rider has canceled the ride.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 illustrates an example graphical user interface (GUI), according to some example embodiments.

FIG. 3 is a flowchart illustrating aspects of a method, according to some example embodiments.

FIG. 4 illustrates an example geographical area that is partitioned into a grid with a plurality of grid cells, according to some example embodiments.

FIG. 5 illustrates an example of a quad tree approach that is defined based on the distribution of points of interest, according to some example embodiments.

FIG. 6 is a flowchart illustrating aspects of a method, according to some example embodiments.

FIG. 7 illustrates an example geographical area that is partitioned into a grid with a plurality of grid cells, according to some example embodiments.

FIG. 8 is a flowchart illustrating aspects of a method, according to some example embodiments.

FIG. 9 is a block diagram illustrating an example of a software architecture that may be installed on a machine, according to some example embodiments.

FIG. 10 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to a location point of interest (POI) generation system. As explained above, in ride sharing services, a rider requesting a ride may enter an incorrect address for a pickup or drop-off location or be unfamiliar with an area and not know a particular address to enter, GPS coordinates may indicate the rider is in a different location than he or she is actually located, and so forth. Also, there are many countries, such as India and Egypt, that do not use physical addresses as a primary way to navigate. Embodiments described herein provide for selecting a set of representative POIs for a location (e.g., neighborhood) to be displayed on a map and improve the user (e.g., rider or driver) experience. A POI can be a landmark or other point of interest, such as a restaurant, park, mall, building, museum, airport, and the like. The POIs can be selected for a pickup or drop-off location or to help with routing and navigation.

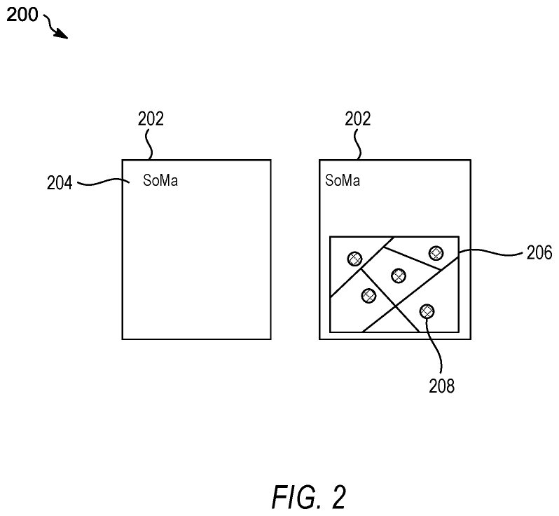

For example, a rider can search for a particular neighborhood (e.g., SoMa in San Francisco) and then select a POI (e.g., landmark) displayed on a map on the rider's computing device. This is a more efficient system than searching directly for an address or point of interest and may result in less error since the rider can visually verify the POI (e.g., for pickup in a ride sharing service). FIG. 2 illustrates a simple example where a user would enter (e.g., via typing or voice) a neighborhood name 204 (e.g., SoMa) into a graphical user interface (GUI) 202. The computing device detects the input and causes display of a map 206 of the neighborhood with a set of selectable POIs, such as POI 208. In one example, a name of the POI and/or address (e.g., Joe's Café, or Joe's Cafeé, on Main Street) is displayed with each POI.

In one example embodiment, a computing system partitions a geographical area to generate a plurality of partitions for the geographical area, determines a plurality of points of interest located in the geographic area, and associates a POI with each partition of the plurality of partitions for the geographical area (e.g., based on popularity and/or a centermost POI). The computing system receives a request for a pickup or drop-off location for a ride share for a location, determines a subset of partitions of the plurality of partitions that correspond to the location, and provides the points of interests associated with the subset of partitions that correspond to the location. In one example embodiment, the points of interests are displayed on a GUI of a computing device for selection of a pickup or drop-off location.

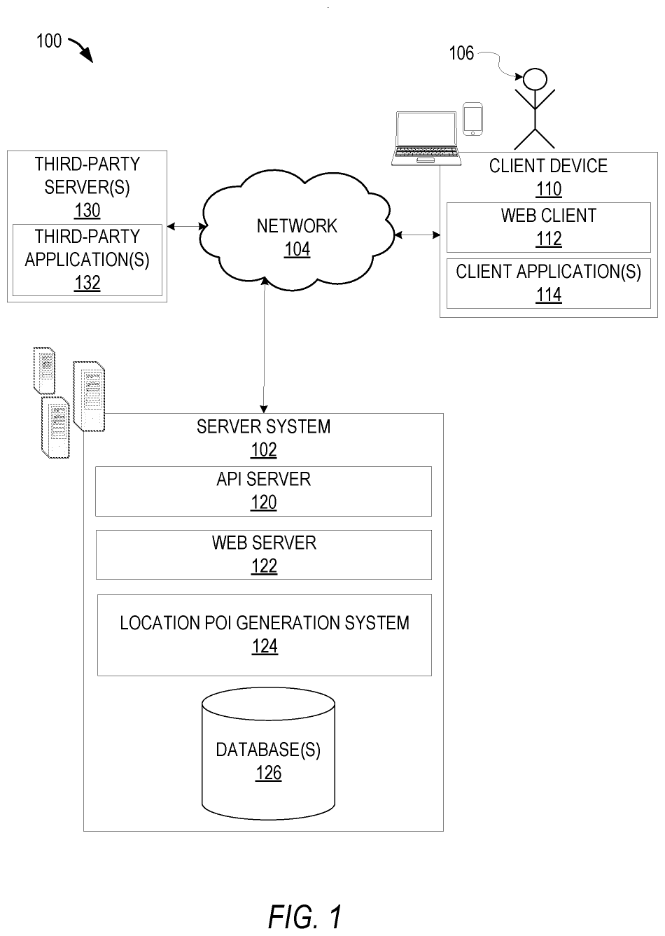

FIG. 1 is a block diagram illustrating a networked system 100, according to some example embodiments. The system 100 includes one or more client devices such as client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 may comprise a display module (not shown) to display information (e.g., in the form of user interfaces). In further embodiments, the client device 110 may comprise one or more of touchscreens, accelerometers, gyroscopes, cameras, microphones, GPS devices, inertial measurement units (IMUs), and so forth. The client device 110 may be a device of a user that is used to request map information, provide map information, request navigation information, receive and display results of map and/or navigation information, request data about a place or entity in a particular location, receive and display data about a place or entity in a particular location, receive and display data about a pickup or drop-off location, receive and display data related to navigation to a pickup or drop-off location, receive and display points of interest for a location (e.g., neighborhood, city), and so forth.

One or more users 106 may be a person, a machine, or other means of interacting with the client device 110. In example embodiments, the user 106 is not part of the system 100 but interacts with the system 100 via the client device 110 or other means. For instance, the user 106 provides input (e.g., touchscreen input or alphanumeric input) to the client device 110 and the input may be communicated to other entities in the system 100 (e.g., third-party servers 130, server system 102) via a network 104. In this instance, the other entities in the system 100, in response to receiving the input from the user 106, communicate information to the client device 110 via the network 104 to be presented to the user 106. In this way, the user 106 interacts with the various entities in the system 100 using the client device 110. In some example embodiments, the user 106 is a rider in a ride-sharing service, a driver in a ride-sharing service, a person desiring information about a rider pick-up and/or drop-off location, or the like.

The system 100 further includes the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WIFI network, a WiMax network, another type of network, or a combination of two or more such networks.

The client device 110 accesses the various data and applications provided by other entities in the system 100 via a web client 112 (e.g., a browser, such as the Internet Explorer® browser developed by Microsoft® Corporation of Redmond, Wash. State) or one or more client applications 114. The client device 110 includes the one or more client applications 114 (also referred to as “apps”) such as, but not limited to, a web browser, a messaging application, an electronic mail (email) application, an e-commerce site application, a mapping or location application, a ride-sharing application, a navigation application, and the like.

In some embodiments, the one or more client applications 114 may be included in the client device 110, and configured to locally provide a user interface and at least some of the functionalities, with the client applications 114 configured to communicate with other components or entities in the system 100 (e.g., third-party servers 130, server system 102), on an as-needed basis, for data and/or processing capabilities not locally available (e.g., to access location information, to request a pickup or drop-off location, to access navigation information, to authenticate the user 106, to verify a method of payment). Conversely, the one or more client applications 114 may not be included in the client device 110, and the client device 110 may use its web browser to access the one or more applications hosted on other entities in the system 100 (e.g., third-party servers 130, server system 102).

The server system 102 provides server-side functionality via the network 104 (e.g., the Internet or a wide area network (WAN)) to one or more third-party servers 130 and/or one or more client devices 110. The server system 102 may include an application programming interface (API) server 120, a web server 122, and a location POI generation system 124, that are communicatively coupled with one or more databases 126.

The one or more databases 126 are storage devices that store data related to one or more of source code, navigation data, pick-up and drop-off locations, a nearest node to a destination location, points of interest and related data (e.g., POI location, POI name, instructions, etc.), trip data (e.g., trip count), and so forth. The one or more databases 126 may further store information related to the third-party servers 130, third-party applications 132, the client device 110, the client applications 114, the user 106, and so forth. The one or more databases 126 may be cloud-based storage.

The server system 102 is a cloud computing environment, according to some example embodiments. The server system 102, and any servers associated with the server system 102, are associated with a cloud-based application, in one example embodiment.

The location POI generation system 124 provides back-end support for the third-party applications 132 and the client applications 114, which may include cloud-based applications. The location POI generation system 124 generates POIs for a geographic area, among other things, as described in further detail below. The location POI generation system 124 comprises one or more servers or other computing devices or systems.

The system 100 further includes one or more third-party servers 130. The one or more third-party servers 130 comprise one or more third-party applications 132. The one or more third-party applications 132, executing on the third-party server(s) 130, interact with the server system 102 via a programmatic interface provided by the API server 120. For example, third-party applications 132 may request and utilize information from the server system 102 via the API server 120 to support one or more features or functions on a website hosted by a third party or an application hosted by the third party. In one example, a third-party application 132 may request and receive POI data, navigation data, pickup and drop-off location data, and so forth, via the server system 102 and the navigation system 124.

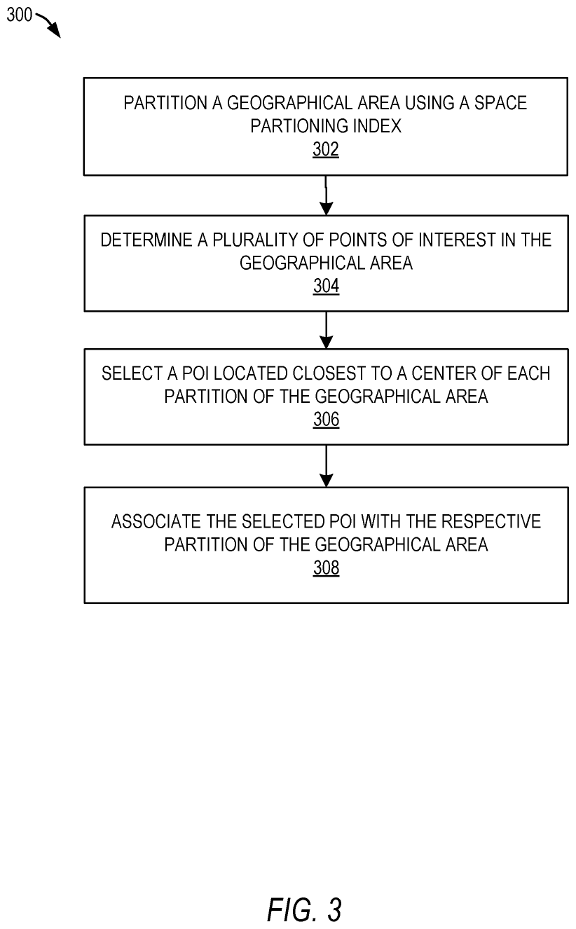

FIG. 3 is a flowchart illustrating aspects of a method 300 for generating POIs for a geographic area, according to some example embodiments. For illustrative purposes, the method 300 is described with respect to the networked system 100 of FIG. 1. It is to be understood that the method 300 may be practiced with other system configurations in other embodiments.

In operation 302, one or more processors of a computing system (e.g., a server system, such as the server system 102 or the location POI generation system 124), partitions a geographical area using a space partitioning index. A geographical area can include any predefined geographical location, such as a state, a city, a neighborhood, a geo-fenced area, and so forth. A space partitioning index may be any method of dividing a space into partitions or subsets.

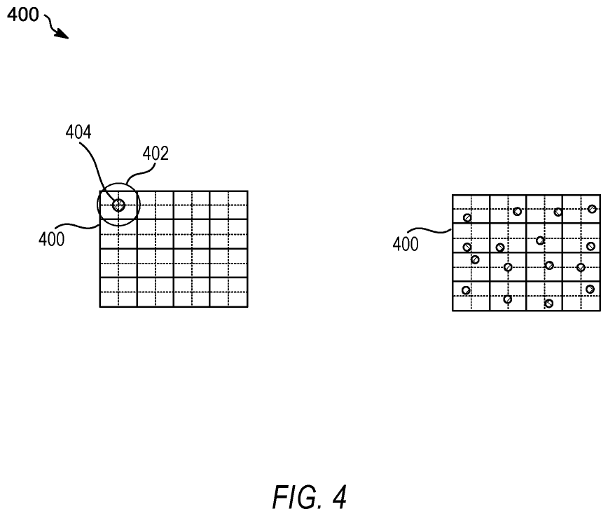

In one example embodiment, a geographical area is divided using a space partitioning index in the form of a grid comprising a plurality of grid cells. It is to be understood that example embodiments can use other types of space partitioning methods or other shapes (e.g., a rectangle or other polygon, a circular or oval shape). FIG. 4 illustrates an example geographical area that is partitioned into a grid 400 with a plurality of grid cells, such as grid cell 402. In the example shown in FIG. 4, all the grid cells are of a same size. The size of the grid cells can be predetermined (e.g., default size) or determined based on the density of a location. For example, all grid cells for each grid for each geographical area can be the same or similar predefined size, or grid cells can vary depending on a density or sparsity of a location, and so forth. FIG. 4 is described in further detail below.

In one example embodiment, instead of a same size for each grid cell for a grid for a geographical area, a quad tree approach is used to partition the space of the geographical area. For example, using uniform grid cells for each grid for each geographical area assumes that POI, address, and road network distribution is uniform in a geographical area. However, this is not always the case. For example, a city in India would have a very different layout and density of POIs and addresses and a different road network distribution than a rural town in India.

A quad tree is a tree data structure that can be used to partition a space by recursively subdividing the space into four quadrants or regions. The subdivided regions may be square, rectangular, or have an arbitrary shape. In one example embodiment, a quad tree is defined based on a distribution of POIs. For example, a quadtree can be generated for each geographical area (e.g., city, neighborhood) based on a distribution of all the POIs in the geographical area.

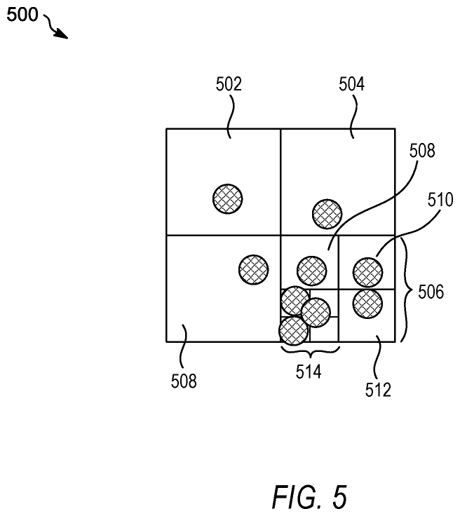

FIG. 5 illustrates a simple example of a quad tree approach that is defined based on the distribution of POIs. In this example, grid 500 represents a geographical area (e.g., a city). The round circles each represent a POI in the geographical area, thus collectively representing all the POIs in the geographical area. First, the computing system divides the geographical area into four equal partitions. This is shown in the example grid 500 as grid cells 502, 504, 506, and 508. Then, based on a predetermined threshold number of POIs that can be in each cell, the computing system recursively adds more partitions. For example, if a number of POIs in a given grid cell is greater than a predetermined number (e.g., 2, 5, 10), then the computing system divides the given grid cell again into four equal partitions. The computing system continues recursively adding more partitions until each grid cell has no greater than a predetermined number of POIs or until a max threshold of grid cells are generated.

Grid cells 502, 504, and 508 each only have only one POI (e.g., less than a threshold number of POIs). But grid cell 506 has six POIs (e.g., greater than a threshold number of POIs). Thus, the computing system further divides grid cell 506 into four equal grid cells 508, 510, 512, and 514 and then further divides grid cell 514 into four equal grid cells. In this way, the computing system calculates or determines the partitions and each partition size in the geographical area. Moreover, using a quad tree approach can partition a geographical area such that denser areas have more partitions and less dense areas have less partitions.

The computing device can then store the computed partitions (e.g., the grid and corresponding grid cells) for the geographical area (e.g., in one or more databases 126). For example, the computing device can store the quad tree hierarchical structure and pointers to POIs. In one example, the partitioned area can be stored in a spatial database where each grid can be a row in the system.

Returning to FIG. 3, in operation 304, the computing system determines a plurality of POIs in the geographical area. For example, the computing system accesses one or more data stores (e.g., databases 126 and/or third-party data stores) to determine POIs with locations within the geographical area. The data stores may further comprise data associated with each POI, such as a name of the POI, the location of the POI (e.g., an address, geographical coordinates (e.g., latitude/longitude), a street associated with the POI, etc.), instructions associated with the POI, a trip count associated with the POI, and so forth.

In many instances there are a significant number of POIs in a particular geographical area (e.g., in a densely populated city with many restaurants, theaters, landmarks, etc.) and generating and displaying all of the POIs would be very resource consuming and could be confusing to a user. Accordingly, in example embodiments, the computing system selects only a subset of the POIs for a geographical area to minimize resource consumption, time to display POIs in a display on a computing device, and confusion for a user (e.g., rider or driver). In operation 306, the computing system selects one POI located closest to a center portion of each partition of the geographical area. For example, the computing system determines a center of a grid cell, as can be seen in FIG. 4, where the dotted cross marks in grid cell 402 meet to define a center point 404 of the grid cell 402. The computing system can then determine, for each grid cell of the grid 400, one point of interest that has a location closest to the location of the center portion of the grid cell.

For example, the computing system determines one POI, of a plurality of POIs located within the grid cell, that has a location (e.g., address, geographical coordinates) that is closest to the location of the center point 404 of grid cell 402. The POIs are represented as circles and shown in the right-hand representation of grid 400. The example grid 400 of FIG. 4 comprises uniform grid cells, as described above. It is to be understood that the grid 400 can also be generated based on a quad tree method as described above. Using the quad tree method, the computing system has already determined the plurality of points of interest in the geographical area.

In some instances, there may be more than one POI located the same distance to the center portion of a partition. In that case, the computing system selects one POI based one or more factors, such as randomly choosing one POI of the POIs equally close to the center portion of the partition, choosing the most popular POI (e.g., the POI with the highest trip count as described below), and/or another factor.

In some instances, there may be a partition that does not comprise a POI. In this case, the computing system can select one address that is closest to the center of a grid.

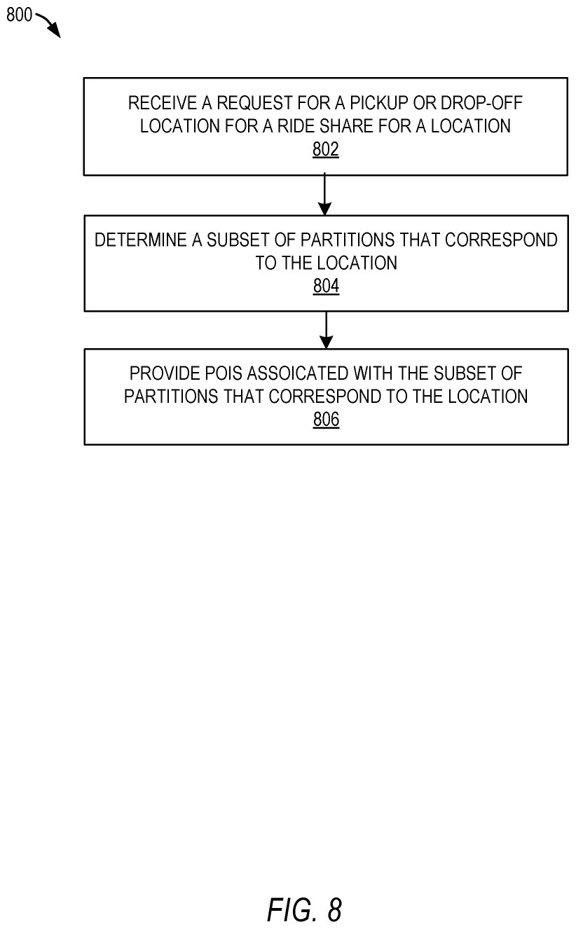

Returning to FIG. 3, in operation 308, the computing system associates the selected POI with the respective partition of the geographical area. For example, the computing system stores data associated with the POI (e.g., POI name, POI address, etc.) with the corresponding partition in one or more data stores (e.g., databases 126). The stored partitions and associated POIs can be used to respond to a request for a pickup or drop-off location, as explained below with respect to FIG. 8. The computing system can periodically update the partitioning and/or POIs selected for each partition (e.g., based on updated trip count data, changes in POIs, and so forth).

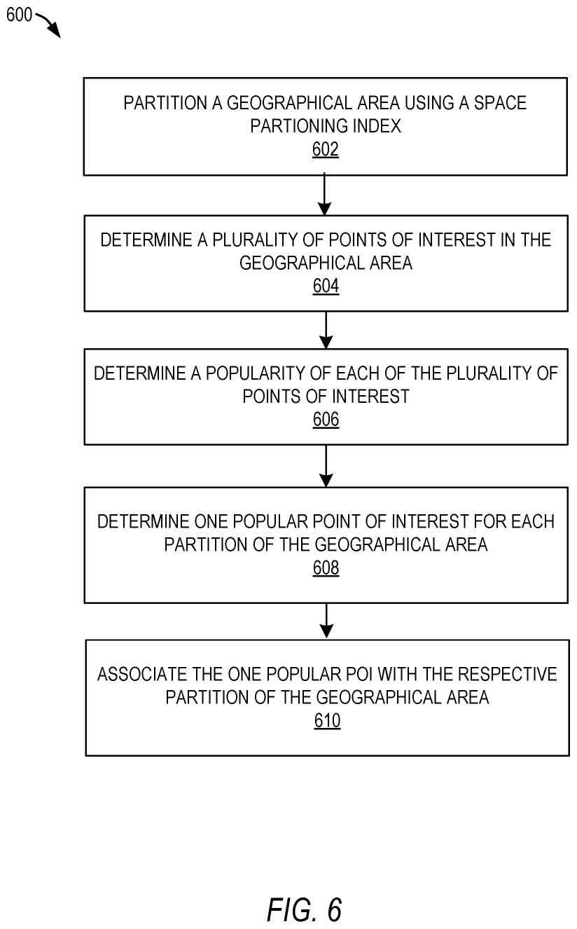

FIG. 6 is a flowchart illustrating aspects of a method 600 for generating POIs for a geographic area, according to some example embodiments. For illustrative purposes, the method 600 is described with respect to the networked system 100 of FIG. 1. It is to be understood that the method 600 may be practiced with other system configurations in other embodiments.

In operation 602, one or more processors of a computing system (e.g., a server system, such as the server system 102 or the location POI generation system 124), partitions a geographical area using a space partitioning index, and in operation 604, the computing system determines a plurality of POIs in the geographical area, as described above with respect to operation 302 and operation 304.

In operation 606, the computing system determines a popularity of each of the plurality of points of interest. In one example embodiment, the computing system determines a popularity of each of the plurality of points of interest based on a trip count. The trip count comprises at least one of a number of ridesharing pickups or a number of ridesharing drop-offs at the point of interest. For example, a ridesharing system adds a count for each time a pickup or drop-off is made at the POI (or a predefined distance from the POI, such as 20 meters). For example, a POI may be Joe's Café. Each time the ride-sharing system detects that a rider is picked up or dropped off at Joe's Café, it adds a count in a data store associated with the POI. Trips counts may be stored for a specified time frame, such as within a last week or month. The computing system accesses the trip count stored and associated with the POI for use in determining the popularity of a POI.

In another example embodiment, a POI may have an associated category and the computing system can determine the popularity based on the category. For example, a tourist attraction category could be assumed to be a popular POI.

In operation 608, the computing system determines, for each partition of the plurality of partitions of the geographical area, one popular POI located within the partition. In one example embodiment, the computing system selects the one popular POI based on the POI located within the partition that has the highest trip count. In this embodiment, instead of selecting a POI that is closest to a center point of a partition (as described above), the computing system selects one popular (or most popular) POI located within the partition. In the event that there are two POIs for a partition with the same highest trip count, one can be chosen randomly or based on other factors, such as national importance of a landmark, a trip count in different time periods (e.g., in the last two weeks, last month), or other factors.

In one example embodiment, after determining the popularity of each of the plurality of POIs in operation 606, the computing system selects a subset of the plurality of POIs that have a popularity value (e.g., trip count) over a predetermined threshold popularity value (e.g., predetermined threshold trip count). In this example embodiment, the computing system determines, for each partition of the plurality of partitions of the geographical area, one popular POI of the elected subset of the plurality of POIs (e.g., with the highest trip count). In this way, only the most popular POIs are considered for a partition.

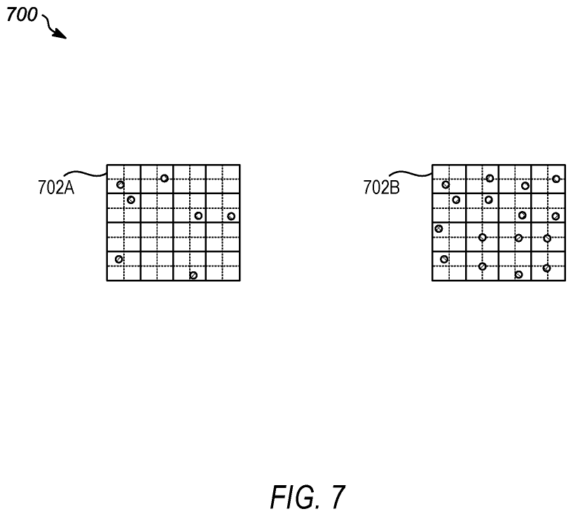

It is possible that there are some partitions that do not have a popular POI. In this case, where the computing system determines that at least one partition of the plurality of partitions does not comprise a POI, the computing system can use the method previously described to select a POI located a closest distance to a center point of the at least one partition. FIG. 7 illustrates an example 700 where only a subset of the partitions (e.g., grid cells of grid 702A) have a popular POI (POIs indicated by circles). And thus, the computing system populates the partitions without a popular POI by selecting a POI that is closest to a center point of each of the partitions that do not have a popular POI, as shown in 702B.

In operation 610, the computing system associates the one popular POI with the respective partition of the geographical area, as described above with respect to operation 308. The computing system can periodically update the partitioning and/or POIs selected for each partition (e.g., based on updated trip count data, changes in POIs, and so forth).

FIG. 8 is a flowchart illustrating aspects of a method 800 for responding to a request for a pickup or drop-off location, according to some example embodiments. For illustrative purposes, the method 800 is described with respect to the networked system 100 of FIG. 1. It is to be understood that the method 800 may be practiced with other system configurations in other embodiments.

In operation 802, one or more processors of a computing system (e.g., a server system, such as the server system 102 or the location POI generation system 124), receives a request for a pickup or drop-off location for a ride share for a location. For example, a user (e.g., a rider or driver) enters a neighborhood (e.g., SoMa), an address, or the like, into a computing device to request a ride share (e.g., a vehicle) and the computing device sends a request for a pickup or drop-off location based on the rider entry. In addition, or in the alternative, the computing device sends geographical coordinates (e.g., latitude, longitude) corresponding to a location of the computing device. The computing system receives the request from the computing device.

In operation 804, the computing system determines a subset of partitions of a plurality of partitions that correspond to the location. For example, the computing system accesses the stored partitions that were previously generated (e.g., via the methods described with respect to FIG. 3 and FIG. 6), to select the partitions that correspond (e.g., cover) the location for which a pickup or drop-off is requested. In one example embodiment, the computing system determines a neighborhood that corresponds to the location (e.g., SoMa) either based on an address or geographical coordinates received from the computing device or a neighborhood specified by the requesting rider, and determines the subset of partitions of the plurality of partitions that corresponds to the neighborhood (e.g., covers the neighborhood area).

In operation 806, the computing system provides the POIs associated with the subset of partitions that correspond to the location. The computing system can provide the POIs to the computing device to be displayed for selection for a pickup and/or drop-off location. For example, the POIs and corresponding name (and optionally address or other information) can be displayed on a GUI of the computing device so that the user of the computing device can orient himself or herself and select a POI for a pickup or drop-off location.

In one example embodiment, instead of partitioning a geographical area and determining POIs for the portioned geographical area in advance, the computing system can perform the operations of FIG. 3 and/or FIG. 6 in real time or near real time in response to a request for a pickup or drop-off location. In one example embodiment, when performing such operations in real time or near real time, the computing system can also take into account the user's historical pickup and drop-off locations in selecting a POI for each partition. For example, a user may regularly get picked up or dropped off outside of his or her place of work and thus, the computing system can select a POI selected to the place of work or near the place of work for the partition that corresponds to the place of work.

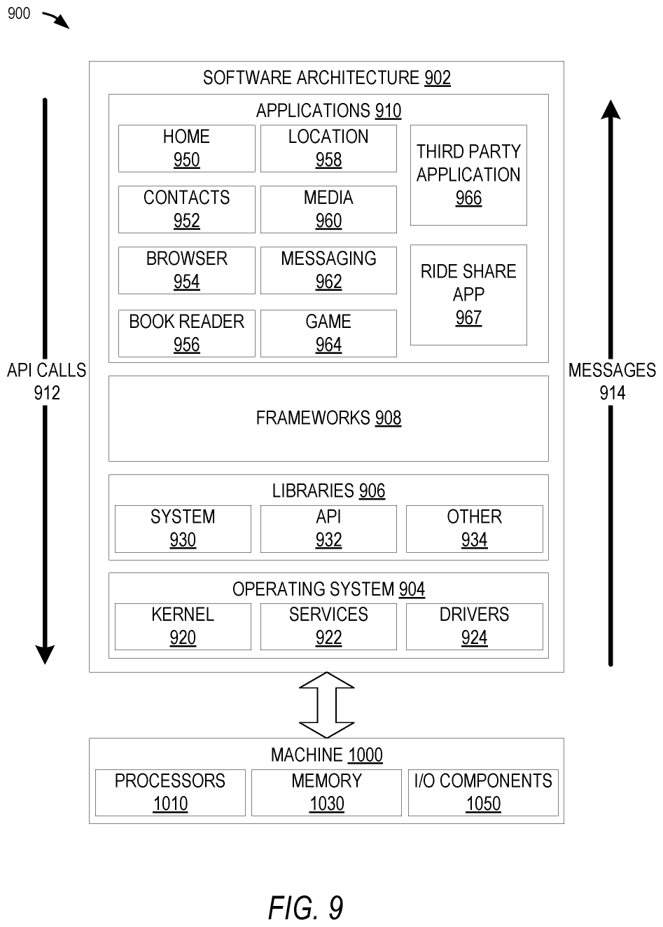

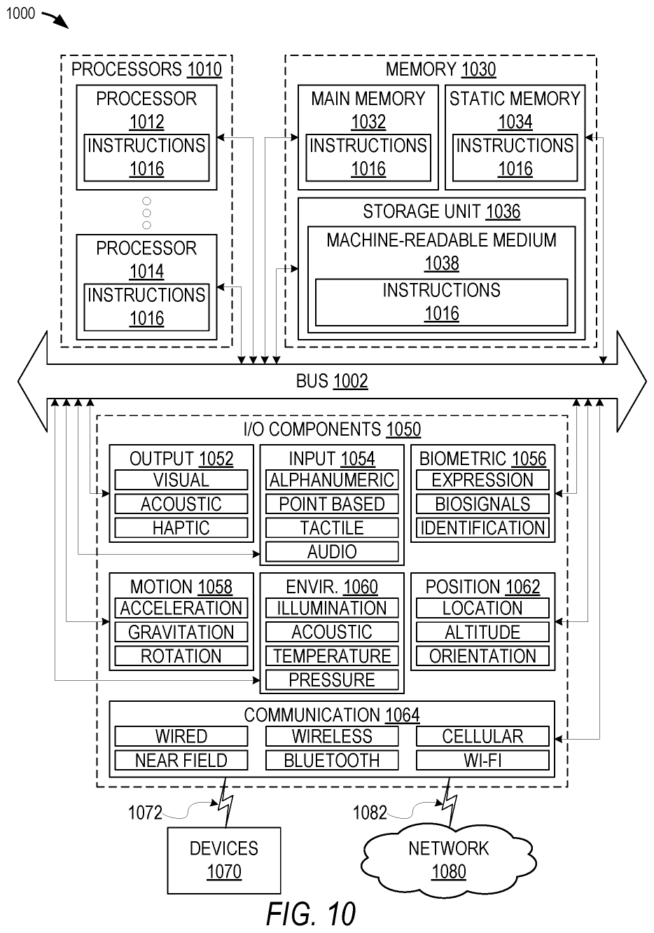

FIG. 9 is a block diagram 900 illustrating a software architecture 902, which can be installed on any one or more of the devices described above. For example, in various embodiments, client devices 110 and servers and systems 130, 102, 120, 122, and 124 may be implemented using some or all of the elements of the software architecture 902. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke application programming interface (API) calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematical functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

Some embodiments may particularly include a ride sharing application 967. In certain embodiments, this may be a standalone application that operates to manage communications with a server system such as third-party servers 130 or server system 102. In other embodiments, this functionality may be integrated with another application (e.g., a mapping or navigation application). The ride sharing application 967 may request and display various data related to pickup and drop-off locations, POIs, mapping and navigation, and so forth, and may provide the capability for a user 106 to input data related to the objects via a touch interface, via a keyboard, or using a camera device of the machine 1000; communicate with a server system via the I/O components 1050; and receive and store object data in the memory 1030. Presentation of information and user inputs associated with the information may be managed by the ride sharing application 967 using different frameworks 908, library 906 elements, or operating system 904 elements operating on the machine 1000.

FIG. 10 is a block diagram illustrating components of a machine 1000, according to some embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application 910, an applet, an app, or other executable code) for causing the machine 1000 to perform any one or more of the methodologies discussed herein can be executed. In alternative embodiments, the machine 1000 operates as a standalone device or can be coupled (e.g., networked) to other machines. In a networked deployment, the machine 1000 may operate in the capacity of a server machine or system 130, 102, 120, 122, 124, etc., or a client device 110 in a server-client network environment, or as a peer machine in a peer-to-peer (or distributed) network environment. The machine 1000 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

In various embodiments, the machine 1000 comprises processors 1010, memory 1030, and I/O components 1050, which can be configured to communicate with each other via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 1012 and a processor 1014 that may execute the instructions 1016. The term “processor” is intended to include multi-core processors 1010 that may comprise two or more independent processors 1012, 1014 (also referred to as “cores”) that can execute instructions 1016 contemporaneously. Although FIG. 10 shows multiple processors 1010, the machine 1000 may include a single processor 1010 with a single core, a single processor 1010 with multiple cores (e.g., a multi-core processor 1010), multiple processors 1012, 1014 with a single core, multiple processors 1012, 1014 with multiple cores, or any combination thereof.

The memory 1030 comprises a main memory 1032, a static memory 1034, and a storage unit 1036 accessible to the processors 1010 via the bus 1002, according to some embodiments. The storage unit 1036 can include a machine-readable medium 1038 on which are stored the instructions 1016 embodying any one or more of the methodologies or functions described herein. The instructions 1016 can also reside, completely or at least partially, within the main memory 1032, within the static memory 1034, within at least one of the processors 1010 (e.g., within the processor's cache memory), or any suitable combination thereof, during execution thereof by the machine 1000. Accordingly, in various embodiments, the main memory 1032, the static memory 1034, and the processors 1010 are considered machine-readable media 1038.

As used herein, the term “memory” refers to a machine-readable medium 1038 able to store data temporarily or permanently and may be taken to include, but not be limited to, random-access memory (RAM), read-only memory (ROM), buffer memory, flash memory, and cache memory. While the machine-readable medium 1038 is shown, in an example embodiment, to be a single medium, the term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., the instructions 1016) for execution by a machine (e.g., the machine 1000), such that the instructions, when executed by one or more processors of the machine (e.g., the processors 1010), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1050 include a wide variety of components to receive input, provide output, produce output, transmit information, exchange information, capture measurements, and so on. In general, it will be appreciated that the I/O components 1050 can include many other components that are not shown in FIG. 10. The I/O components 1050 are grouped according to functionality merely for simplifying the following discussion, and the grouping is in no way limiting. In various example embodiments, the I/O components 1050 include output components 1052 and input components 1054. The output components 1052 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1054 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touchscreen that provides location and force of touches or touch gestures, or other tactile input components), audio input components (e.g., a microphone), and the like.

In some further example embodiments, the I/O components 1050 include biometric components 1056, motion components 1058, environmental components 1060, or position components 1062, among a wide array of other components. For example, the biometric components 1056 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 include acceleration sensor components (e.g., accelerometer), gravitation sensor components, rotation sensor components (e.g., gyroscope), and so forth. The environmental components 1060 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1062 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 include a network interface component or another suitable device to interface with the network 1080. In further examples, the communication components 1064 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 1070 may be another machine 1000 or any of a wide variety of peripheral devices (e.g., a peripheral device coupled via a Universal Serial Bus (USB)).

Moreover, in some embodiments, the communication components 1064 detect identifiers or include components operable to detect identifiers. For example, the communication components 1064 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D barcodes, and other optical codes), acoustic detection components (e.g., microphones to identify tagged audio signals), or any suitable combination thereof. In addition, a variety of information can be derived via the communication components 1064, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1080 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 1016 are transmitted or received over the network 1080 using a transmission medium via a network interface device (e.g., a network interface component included in the communication components 1064) and utilizing any one of a number of well-known transfer protocols (e.g., Hypertext Transfer Protocol (HTTP)). Similarly, in other example embodiments, the instructions 1016 are transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

Furthermore, the machine-readable medium 1038 is non-transitory (in other words, not having any transitory signals) in that it does not embody a propagating signal. However, labeling the machine-readable medium 1038 “non-transitory” should not be construed to mean that the medium is incapable of movement; the machine-readable medium 1038 should be considered as being transportable from one physical location to another. Additionally, since the machine-readable medium 1038 is tangible, the machine-readable medium 1038 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
partitioning, by one or more processors of a computing system, a geographical area to generate a plurality of partitions for the geographical area;
determining, by the one or more processors of the computing system, a plurality of points of interest located in the geographic area;
determining, by the one or more processors of the computing system, a popularity of each of the plurality of points of interest based on a trip count comprising at least one of a number of ridesharing pickups or a number of ride-sharing drop-offs at the point of interest;
for each partition of the plurality of partitions of the geographical area, determining one popular point of interest located within the partition and associating the one popular point of interest with the partition;
receiving, by one or more processors of the computing system, a request for a pickup or drop-off location for a ride share for a location;
determining, by the one or more processors of the computing system, a subset of partitions of the plurality of partitions that correspond to the location; and
providing the points of interests associated with the subset of partitions that correspond to the location, wherein the points of interests are displayed for selection of a pickup or drop-off location.

2. The method of claim 1, wherein partitioning the geographical area comprises generating a grid comprising a plurality of grid cells for the geographical area.

3. The method of claim 1, wherein generating the grid comprises generating the grid with each of the plurality of grid cells having a same predetermined size.

4. The method of claim 1, wherein partitioning the geographical area comprises using a quad tree to partition the geographical area into a plurality of grid cells each with a size based on a distribution of points of interest within the geographical area.

5. The method of claim 1, wherein determining the plurality of points of interest located in the geographical area comprises accessing one or more data stores to determine a plurality of points of interest located in the geographical area.

6. The method of claim 1, wherein determining the one popular point of interest located within the partition is based on determining that the one popular point of interest of a plurality of points of interest located in the partition is associated with a highest trip count.

7. The method of claim 1, wherein after determining a popularity of each of the plurality of the plurality of points of interest based on a trip count, the method comprises:
selecting a subset of the plurality of points of interest that have a popularity value over a predetermined threshold popularity value; and
wherein determining one popular point of interest located within the partition and associating the one popular point of interest with the partition comprises determining one popular point of interest, of the selected subset of the plurality of points of interest, and associating the one popular point of interest with the partition.

8. The method of claim 7, wherein selecting the subset of the plurality of points of interest that have a popularity value over a predetermined threshold is based on each of the subset of points of interest having a trip count greater than a predetermined threshold trip count.

9. The method of claim 7, further comprising:
determining that at least one partition of the plurality of partitions does not comprise a popular point of interest;
determining a point of interest located in the at least one partition that is the closest to a center point of the at least once partition; and
associating the point of interest that is the closest to a center point with the at least one partition.

10. The method of claim 1, wherein the location is a specified neighborhood and determining a subset of partitions of the plurality of partitions that correspond to the location comprises determining the subset of partitions of the plurality of partitions that corresponds to the specified neighborhood.

11. The method of claim 1, wherein the location comprises geographical coordinates and the method further comprises:
determining a neighborhood corresponding to the geographical coordinates; and
determining the subset of partitions of the plurality of partitions that corresponds to the specified neighborhood.

12. A computing system comprising:
a memory that stores instructions; and
one or more processors configured by the instructions to perform operations comprising:
partitioning a geographical area to generate a plurality of partitions for the geographical area;
determining a plurality of points of interest located in the geographic area;
determining a popularity of each of the plurality of points of interest based on a trip count comprising at least one of a number of ridesharing pickups or a number of ride-sharing drop-offs at the point of interest;
for each partition of the plurality of partitions of the geographical area, determining one popular point of interest located within the partition and associating the one popular point of interest with the partition;
receiving a request for a pickup or drop-off location for a ride share for a location;
determining a subset of partitions of the plurality of partitions that correspond to the location; and
providing the points of interests associated with the subset of partitions that correspond to the location, wherein the points of interests are displayed for selection of a pickup or drop-off location.

13. The computing system of claim 12, wherein partitioning the geographical area comprises generating a grid comprising a plurality of grid cells for the geographical area, with each of the plurality of grid cells having a same predetermined size.

14. The computing system of claim 12, wherein partitioning the geographical area comprises using a quad tree to partition the geographical area into a plurality of grid cells each with a size based on a distribution of points of interest within the geographical area.

15. The computing system of claim 12, wherein determining the one popular point of interest located within the partition is based on determining that the one popular point of interest of a plurality of points of interest located in the partition is associated with a highest trip count.

16. The computing system of claim 12, wherein after determining a popularity of each of the plurality of the plurality of points of interest based on a trip count, the operations comprise:
selecting a subset of the plurality of points of interest that have a popularity value over a predetermined threshold popularity value; and
wherein determining one popular point of interest located within the partition and associating the one popular point of interest with the partition comprises determining one popular point of interest, of the selected subset of the plurality of points of interest, and associating the one popular point of interest with the partition.

17. The computing system of claim 16, wherein selecting the subset of the plurality of points of interest that have a popularity value over a predetermined threshold is based on each of the subset of points of interest having a trip count greater than a predetermined threshold trip count.

18. The computing system of claim 16, further comprising:
determining that at least one partition of the plurality of partitions does not comprise a popular point of interest;
determining a point of interest located in the at least one partition that is the closest to a center point of the at least once partition; and
associating the point of interest that is the closest to a center point with the at least one partition.

19. The computing system of claim 12, wherein the location is a specified neighborhood and determining a subset of partitions of the plurality of partitions that correspond to the location comprises determining the subset of partitions of the plurality of partitions that corresponds to the specified neighborhood.

20. A non-transitory computer-readable medium comprising instructions stored thereon that are executable by at least one processor to cause a computing system to perform operations comprising:
partitioning a geographical area to generate a plurality of partitions for the geographical area;
determining a plurality of points of interest located in the geographic area;
determining a popularity of each of the plurality of points of interest based on a trip count comprising at least one of a number of ridesharing pickups or a number of ride-sharing drop-offs at the point of interest;
for each partition of the plurality of partitions of the geographical area, determining one popular point of interest located within the partition and associating the one popular point of interest with the partition;
receiving a request for a pickup or drop-off location for a ride share for a location;
determining a subset of partitions of the plurality of partitions that correspond to the location; and
providing the points of interests associated with the subset of partitions that correspond to the location, wherein the points of interests are displayed for selection of a pickup or drop-off location.
